(19) United States
(12) Patent Application Publication
(10) Pub. No.: US 2006/0098815 A1
(43) Pub. Date: May 11, 2006

(54) Methods of encoding and decoding data

(76) Inventor: Sean O'Neil, Fortitude Valley (AU)

Correspondence Address: HOFFMAN, WASSON & GITLER, P.C.;Crystal Center 2, Suite 522, 2461 South Clark Street, Arlington, VA, 22202, US

(21) Appl. No.: 11/267,212

(22) Filed: Nov. 7, 2005

(30) Foreign Application Priority Data
Nov. 5, 2004 (AU) 2004906364
Jan. 10, 2005 (AU) 200590087
May 3, 2005 (AU) 2005900002217
Oct. 5, 2005 (WO) PCT/IB05/01499

(51) Int. Cl. H04L 9/28

(52) U.S. Cl. 380/28

(57) ABSTRACT

A cryptographic process (100) receives variable length user data (150) as input and performs an initialization process, at least one pass of at least one pass function and an output function. The pass function the invokes at least one round function (171). Each round function (171) receives inputs which are at least one reversible input (151) selected from the intermediate text (150), at least two irreversible inputs (152, 157) selected from the intermediate text (150), so that each pair of the at least two irreversible inputs (152, 157) are selected from the intermediate text (150) so that they separated by at least one bit of intermediate text (150). The round function (171) generates at least one reversible output (151) that updates the intermediate text (150). The sum of the length of the reversible (151) and irreversible (152, 157) inputs received by the round function (171) from the intermediate text (150) is less than the length of the intermediate text (150) in bits minus eight times the length of the sum of the output bits (151) of the round function (171). The output function (171) ensures each block of intermediate text (150) is updated at least once from the output of a unique round function (171) invocation. The output function releases a set of bits from the intermediate text (150) only after the pass function has updated the intermediate text (150) at least once.

### FIELD OF THE INVENTION

The present invention relates to cryptographic functions.

The present application claims priority from the following applications:

Australian provisional application 2004906364 filed on 5 Nov. 2004;

Australian provisional application 2005900087 filed on 10 Jan. 2005;

Australian provisional application 2005902217 filed on 3 May 2005; and

International Patent Application PCT/IB2005/001499 filed on 10 May 2005, the contents of each of which is incorporated herein by reference.

The present application is also related to our copending International Patent Applications:

PCT/IB2005/001475 filed on 10 May 2005; and

PCT/IB2005/001487 filed on 10 May 2005,

the contents of each of which is incorporated herein by reference.

### BACKGROUND OF THE INVENTION

Throughout this specification, including the claims:
the term ‘secret key material’ refers to material that consists of at least one secret key or material directly derived from that at least one secret key;
the term ‘key material’ is synonymous with the term ‘secret key material; and
blocks of data, key or hash bits are of arbitrary size, not necessarily identical in size, and depend on the function receiving input or generating output.

In the art, a linear cryptographic function ƒ is understood to be a function of any given number of inputs and any given number of outputs such that the relationship between every bit of output and every bit of input is a polynomial of a degree not higher than 1.

A typical linear cryptographic function is a set of bits each of which is a XOR of a number of input bits. All linear cryptographic functions are reversible. There are no irreversible linear cryptographic functions. (An illustration of the sense that the term ‘polynomial’ has in the present art is in the analysis of linear feedback shift registers which is set out at pages 372 to 379 of the book Applied Cryptography: Protocols, Algorithms, and Source Code in C by Bruce Schneier, second edition, 1996.)

A cryptographic function is called reversible regarding a given input if the computational cost of finding the value of that input knowing the output and all other inputs is comparable with the computational cost of calculation of the cryptographic function itself. Addition modulo 2ⁿ, multiplication modulo 2ⁿ and multiplicative inverse modulo 2ⁿ are typical reversible nonlinear cryptographic functions.

A cryptographic function is called irreversible regarding a given input if the computational cost of finding the value of that input knowing the output and all other inputs is either computationally infeasible or extremely high comparing with the computational cost of calculation of the cryptographic function itself. y=x<<<x (x rotated left by x bit) is a typical example of an irreversible nonlinear cryptographic function.

The reversibility of a nonlinear cryptographic function regarding any of its inputs is determined individually for each input. Any given nonlinear cryptographic function may be reversible regarding one input and irreversible regarding another or it can be either reversible or irreversible regarding all its inputs.

For example, a block cipher is a reversible nonlinear cryptographic function regarding its plaintext input, but it is irreversible regarding its key, and a keyed cryptographic hash is irreversible regarding its inputs, data and key.

A linear combination of nonlinear cryptographic functions is also a nonlinear cryptographic function. A nonlinear cryptographic function of a linear combination of its inputs is also a nonlinear cryptographic function. Both these cases are referred to as ‘a nonlinear cryptographic function’ in this specification and are marked according to their reversibility regarding the current block as one of the inputs.

If a nonlinear cryptographic function is reversible regarding one of its inputs x, then a reversible linear or nonlinear combination of that input x or that function's output with any other input is also a nonlinear cryptographic function reversible regarding that input x.

If a nonlinear cryptographic function is irreversible regarding one of its inputs x, then a combination of one or more of its inputs and/or its output with any other cryptographic function, linear or nonlinear, reversible or irreversible is also irreversible regarding that input x.

Cryptographic encryption operations, in general, receive plaintext and generate intermediate text. That intermediate text is received by further cryptographic encryption operations which update a portion of the intermediate text. After yet further encryption operations are completed, the final intermediate text is released as ciphertext.

A cryptographic encryption operation that generates intermediate text, in general, is referred to as a round function. Round functions may in turn invoke sub-round functions.

The same terminology of intermediate text and round function is also used where the overall cryptographic operation is a decryption process.

Ciphers and cryptographic systems are built from well known cryptographic primitives. Examples include constructions of a Feistel network block cipher and a mode of operation that specifies the method of chaining outputs of that block cipher to operate on multiple blocks of data. Block ciphers normally encrypt only very small blocks of data of fixed size. It is rarely necessary to encrypt a small portion of data on its own. Therefore different block chaining modes have been proposed to increase security of such constructions; the first such instance as described in U.S. Pat. No. 4,078,152 (Tuckerman III) published 7 Mar. 1978 in response to the introduction of block ciphers as described in U.S. Pat. No. 3,798,359 (Feistel) published 19 Mar. 1974. The above reference U.S. Pat. No. 4,078,152 (Tuckerman III) introduces ciphertext block chaining (CBC).

Feistel block ciphers such as described in the above reference U.S. Pat. No. 3,797,359 (Feistel) perform round functions that operate on half the block length of the cipher. In turn, these round functions subdivide the block into smaller units of four bits performing 4×4 transposition operations and key-dependent 4×4 substitution box transformations on the intermediate state. At the lowest level of abstraction, a strong block cipher ensures at each bit of the ciphertext block has nonlinear interdependencies on each bit of the plaintext block.

Arbitrarily increasing the width of block ciphers is widely considered by the cryptographic community to increase the difficulty of reasoning concerning the security of the cryptographic system. Several methods have been considered for addressing this active area of research.

One such technique involves the creation of block ciphers from complete cryptographic components and can be found in the school of academic work that derives from the paper ‘How to construct pseudorandom permutations from pseudorandom functions’ by Luby C. Rackoff in SIAM Journal on Computing v17 no 2 (1988) pp 373-386.

One method of creating variable length block ciphers from cryptographic hash functions and stream ciphers of this class can be found in the paper ‘Two Practical and Provably Secure Block Ciphers: BEAR and LION’ by Ross Anderson, Eli Biham, International Workshop on Fast Software Encryption, Lecture Notes in Computer Science, 1996.

The U.S. Pat. No. 5,623,549 (Ritter) published 22 Apr. 1997 and the U.S. Pat. No. 5,727,062 (Ritter) published 10 Mar. 1998 disclose methods of two different methods of achieving variable sized block ciphers and when combined disclose techniques intended to provide guarantees of balance and equal distribution.

The above-referenced U.S. Pat. No. 5,623,549 (Ritter) discloses a balanced block mixing construction function that is adapted to receive two blocks of input and mixes the two blocks in a balanced way, resulting in diffusion, generating two blocks of output. The nearest balanced block mixing constructions can be found in ‘SAFER K-64: A Byte-Orientated Block-Ciphering Algorithm’ by James L. Massey published in Fast Software Encryption, Cambridge Security Workshop Proceedings, Springer-Verlag, 1994: pp 1-17. The SAFER cipher introduced the pseudo-Hadamard transform (PHT) used for the purpose of diffusion described as:
a′=a+b mod 2³²
b′=2a+b mod 2³²

The above-referenced U.S. Pat. No. 5,727,062 (Ritter) illustrates a modified form of cipher-block chaining, as disclosed in the above-referenced U.S. Pat. No. 4,078,152 (Tuckerman III) such that after performing cipher-block chaining from left to right over the entire message to be encoded, the construction proceeds to execute cipher-block chaining from right to left two more times over the message. This requires that message must be encoded sequentially but does not enforce strict sequential decryption; a known and undesirable property of cipher-block chaining. The ability to perform parallel decryption allows an attacker to select any block from the outermost layer of ciphertext blocks to decrypt; additionally an attacker may target decryption of a localized region of ciphertext blocks over multiple layers ignoring surrounding ciphertext material.

### SUMMARY OF THE INVENTION

In one aspect our invention provides a process that receives as input a variable length user data comprising at least 56 octets. The process comprises an initialization process including the initialization of intermediate text which is of the same length as the length of the variable length user data. Also, at least one pass of at least one pass function, each pass function comprising the invocation of at least one round function, each round function receiving inputs comprising at least one reversible input selected from the intermediate text and at least two irreversible inputs selected from the intermediate text. Each pair of the at least two irreversible inputs selected from the intermediate text is separated by at least one bit of intermediate text. At least one reversible output is generated that updates the intermediate text in which the sum of the length of the reversible and irreversible inputs received by the round function from the intermediate text is less than the length of the intermediate text in bits minus eight times the length of the sum of the output bits of the round function. A sequence of steps ensures each block of intermediate text is updated at least once from the output of a unique round function invocation. An output function releases a set of bits from the intermediate text only after the pass function has updated the intermediate text at least once.

In another aspect, an apparatus receives a variable length user data comprising at least 56 octets. The apparatus comprises an initialization module implementing an initialization process. The initialization process comprises the initialization of intermediate text which is of the same length as the length of the variable length user data. A pass function module implements at least one pass of at least one pass function, each pass function comprising the invocation of at least one round function. Each round function receiving inputs comprising at least one reversible input selected from the intermediate text, at least two irreversible inputs selected from the intermediate text. Each pair of the at least two irreversible inputs selected from the intermediate text is separated by at least one bit of intermediate text and generating at least one reversible output that updates the intermediate text. The sum of the length of the reversible and irreversible inputs received by the round function from the intermediate text is less than the length of the intermediate text in bits minus eight times the length of the sum of the output bits of the round function. A sequence of steps ensures each block of intermediate text is updated at least once from the output of a unique round function invocation. An output module implements an output function, the output function releases a set of bits from the intermediate text only after the pass function has updated the intermediate text at least once.

### BRIEF DESCRIPTION OF THE DRAWINGS

FIG. 1 is a flow chart of the first step of the disclosed method; and

FIG. 2 is a flow chart of the second step of the disclosed method.

### DESCRIPTION OF THE INVENTION

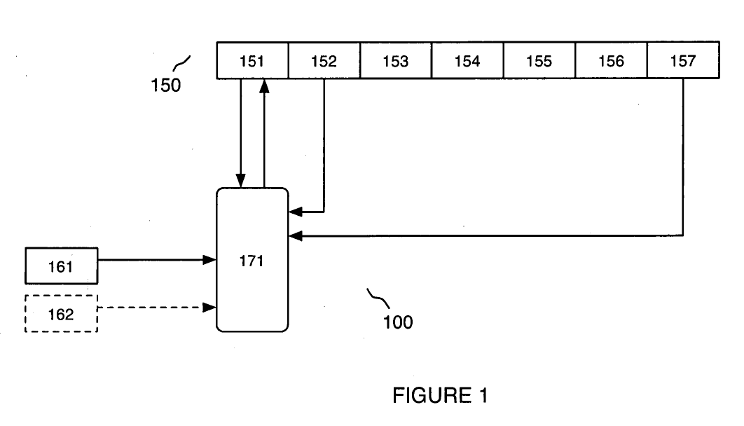

FIG. 1 illustrates a preferred method 100 according to the current invention.

Reference number 150 indicates seven blocks 151, 152, 153, 154, 155, 156 and 157 of intermediate text. The intermediate text 150 is of variable length and is illustrated as 7 blocks in length. The intermediate text 150 is taken as a cyclic contiguous sequence of blocks during coding operations. Block 161 is a block of key material. Round function 171 is adapted to receive reversible input 151 and to receive three blocks 152, 157 and 161 as input irreversible to 152, generating an output updating 151. Block 162 is at least zero blocks of irreversible input.

Each of the at least two irreversible inputs of the function 171 are selected from the intermediate text 150 in a way that ensures that every pair of irreversible inputs is separated by at least one bit of intermediate text.

In a preferred variation of the current embodiment, each bit of the output of the function 171 has a nonlinear dependency on at least two of the at least two irreversible inputs. In an especially preferred variation of the current embodiment, each bit of the output of function 171 has a nonlinear dependency on all of the at least two irreversible inputs.

FIG. 1 accordingly illustrates the coding of the first block 151 of the intermediate text 150. The process of coding is performed by initialization of the variable-length intermediate text 150 followed by the systematic coding of each block of 150.

Intermediate text 150 is initialized by loading the state of a variable length message supplied by the user of the process.

The systematic encoding of the intermediate text 150 starts at the first block 151 as illustrated in FIG. 1.

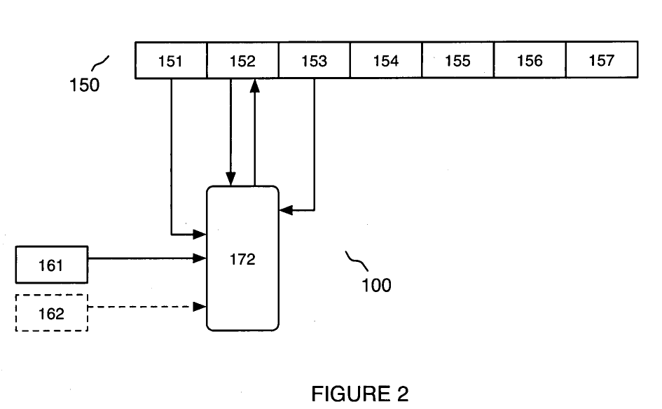

FIG. 2 illustrates the second step of the process of FIG. 1.

Round function 172 is adapted to receive reversible input 152 and receive three blocks 151, 153 and 161 as input irreversible to 152, generating an output updating 152. Block 162 is at least zero blocks of irreversible input. It is preferred that round function 172 is the same as the round function 171 but in FIG. 2 it is given the reference number 172 for ease of discussion.

As in FIG. 1, each of the at least two irreversible inputs of the function 172 are selected from the intermediate text 150 in a way that ensures that every pair of irreversible inputs is separated by at least one bit of intermediate text.

The construction proceeds to encode the second block 152 of intermediate text 150 as illustrated in FIG. 2. The updated block 151 of the round function 171 as illustrated in FIG. 1 is supplied as one of the irreversible inputs of the current round function 172 in FIG. 2. The process of taking as irreversible input into the current round 172, the reversible output of the previous round 171 propagates the influence of the previously encoded rounds forward in time. A result of the process as describe is that after the second block 152 has been encoded, the block 151 cannot be reversed without first decoding block 152.

The construction proceeds to encode the blocks 153, 154, 155, 156 and 157, selecting irreversible inputs regarding the output from cyclic neighbouring inputs either side of the block to be encoded. The process of systematically coding each block of the intermediate state 150 as described is called a ‘pass’.

As previously described, the first block cannot be decoded until the blocks 157, 156, 155, 154, 153 and 152 have been decoded in reverse chronological order.

In a further preferred embodiment, at least one additional irreversible input 162 is selected as input into the round function. In a further preferred variation, at least one additional irreversible input from the intermediate text is selected as input into the round function.

In a preferred embodiment of the current invention, the round function implements a cryptographically secure function and the number of passes is one, advantageously ensuring the strict sequential decryption properties.

In a preferred embodiment, the cyclic contiguous blocks are updated by contiguously neighbouring operations as illustrated in FIG. 1 and FIG. 2.

Further embodiments that we will now describe further ensure each encoded block has a dependency on every block of the original user supplied variable length message.

In one of these variations, after the first pass of encoding, resulting in each of the blocks 151 to 157 of the intermediate text being encoded once, the encoding of blocks 151 to 157 is repeated at least once more. The first block 151 encoded during the second pass takes as irreversible input the block 157 that has a dependency on all seven blocks encoded in the first pass. This chaining process proceeds for each block encoded in the second pass and subsequent passes. It can be seen that each subsequent pass of encoding ensures that each block, which is encoded in that pass, has a dependency on each block of the previous pass.

It is preferred the number of full passes is at least three and a prime number.

Where a single invocation of a round function is not a secure cryptographic function, it is preferred that a minimum number of rounds are executed by the process.

In a preferred embodiment the minimum number of rounds is determined by the following process:

a. Determine the number of rounds required for the output of the successive round functions to be computationally indistinguishable from random; and

b. Set the minimum number of rounds as a multiple of at least 3 times the number of rounds determined by the step a.

In a preferred variation, the multiple in step b is an odd number. In an especially preferred variation, the multiple in step b is a prime number.

The minimum number of passes is then determined by the following process:

c. Calculate the number of passes achieved by the number of rounds in step b by dividing the length of the intermediate text (calculated in units equal to the length of the output of the round function used to update the intermediate text) by the number of rounds determined by step b.

d. Round up the number of passes determined in step c up to the nearest number of passes of at least three in number.

In a preferred variation, the number of passes selected in step d is rounded up to the nearest odd number. In an especially preferred variation, the number of passes selected in step d is rounded up to the nearest prime.

For instance, assume that the number of rounds required to achieve computational indistinguishability from random is determined as nine rounds. The minimum number of rounds is then selected as five times nine rounds giving forty-five rounds. If the intermediate state is seven blocks as illustrated the number of passes to achieve the minimum number of rounds is approximately 6.4 passes. The number of passes is then rounded up to the nearest prime number seven, giving a total of seven passes, resulting in forty-nine rounds of execution.

For a variable length message of 128 blocks in length, encoding one pass of the full message on its own requires more than forty-five rounds, resulting in three passes of 128 blocks for a total of 384 rounds of execution.

It is to be appreciated that security of the present invention increases with the increase in the length of the intermediate text beyond the minimum number of rounds required to achieve a minimum level of security.

In a preferred variation of any of the described embodiments the variable length block is fixed and the number of rounds fixed.

In another preferred embodiment of the invention illustrated in FIG. 1 and FIG. 2, the block length is 128 bits and the round function 171 and 172 is a 256-bit key block cipher. In a preferred variation of the currently described embodiment, the 256-bit key block cipher has a reduced number of rounds and the minimum number of rounds for secure operation determined by the above process.

Encoding and decoding performed by the round function correspond to the two modes of block cipher operation encryption and decryption. The 256 bits of irreversible input are supplied as 256 bits of key material to the round function. In a preferred variation of the current embodiment, secret key material is combined with the two blocks of intermediate text supplied as irreversible inputs supplied as key bits to the round function. In a further preferred variation of the current embodiment, the inputs to the key bits are further combined using pseudo-Hadamard transformations for diffusing the two blocks of intermediate text supplied as irreversible inputs.

In a preferred embodiment of the invention, the round function is a tweakable block cipher such that the tweakable input is adapted to receive irreversible input regarding the reversible input according to the current invention.

In a preferred embodiment of the current invention, the variable length message to be encoded by at least one pass has previously been securely encoded by an encryption method that does not enforce strict sequential decryption.

In a preferred embodiment module 171 is unkeyed transformation. The output of module 171 is adapted as plaintext input to a secure keyed block cipher and the output of the block cipher updates 152. Decryption is performed by the binary reverse operations.

In an alternate but binary equivalent implementation of the preceding embodiments the intermediate text is initialized by the first pass of coding operations where the round function is adapted to receive the variable length user data to be transformed independently from the intermediate text that receives the output of the round function.

In a preferred embodiment the blocks are thirty-two bits in length executing on a thirty-two bit processor with thirty-two-bit wide operations efficient on the thirty-two bit processor. In a preferred embodiment the blocks are sixty-four bits in length executing on a sixty-four bit processor with sixty-four bit wide operations efficient on the sixty-four bit processor.

In a preferred variation of any of the described embodiments, the maximum length of the intermediate text is selected to ensure the coding of the intermediate text fits in the cache memory of a specific set of modem processors.

In a preferred variation of any of the described embodiments, the intermediate text is encoded with a portion of pseudo-random padding to ensure identical messages generate unique outputs.

In a preferred variation of any of the described embodiments, a subset of an encoded ciphertext by the current invention is chained to the next block to be encoded as reversible input to round function resulting in a CBC mode of operation.

Traditionally, round functions of Feistel style block ciphers are adapted to receive no less than half the cipher block length as input to the round function. It will be appreciated in preferred embodiments of current invention the round function receives only a small subset of the intermediate text as input updating a single block of intermediate text enabling the encoding of extremely large blocks.

In a preferred embodiment of the current invention, only a portion of the final intermediate text is released as output as a hash of the variable length user data. In an especially preferred variation when generating a hash and where a single invocation of a round function is not a secure cryptographic hash function, the multiple in step b is at least five. In an especially preferred variation when generating a hash and where a single invocation of a round function is not a secure cryptographic hash function, the number of passes in step d is at least five.

Although we have described detailed embodiments of the invention, with a number of variations, which incorporate the teachings of the present invention, the skilled reader of this specification can readily devise other embodiments and applications of the present invention that utilize these teachings.

1. A process that receives as input variable length user data comprising at least 56 octets, the process comprising:
an initialization process comprising the initialization of intermediate text which is of the same length as the length of the variable length user data;
at least one pass of at least one pass function, each pass function comprising:
the invocation of at least one round function, each round function:
receiving inputs comprising:
at least one reversible input selected from the intermediate text;
at least two irreversible inputs selected from the intermediate text, so that each pair of the at least two irreversible inputs selected from the intermediate text is separated by at least one bit of intermediate text; and
generating at least one reversible output that updates the intermediate text;
and in which: the sum of the length of the reversible and irreversible inputs received by the round function from the intermediate text is less than the length of the intermediate text in bits minus eight times the length of the sum of the output bits of the round function;
and comprising a sequence of steps that ensures each block of intermediate text is updated at least once from the output of a unique round function invocation; and
an output function which releases a set of bits from the intermediate text only after the pass function has updated the intermediate text at least once.

2. A process as claimed in claim 1, in which at least one round function invocation receives as at least one irreversible input at least a portion of the output of the immediately preceding round function invocation.

3. A process as claimed in claim 1, in which the round function additionally receives at least one irreversible block of input regarding the reversible input.

4. A process as claimed in claim 1, in which each bit of the output of at least one of the round functions has a nonlinear dependency on at least two of the at least two irreversible inputs of the round function.

5. A process as claimed in claim 1, in which the round function is a block cipher with irreversible inputs that are twice the length of its plaintext input.

6. A process as claimed in claim 1, in which a minimum number of rounds is performed before the output function is called, that minimum number of rounds being calculated by the steps comprising:
a. determining the number of rounds required for the output of the successive round functions to be computationally indistinguishable from random; and
b. setting the minimum number of rounds as a multiple of at least 3 times the number of rounds determined by the step a.
c. calculating the number of passes achieved by the number of rounds in step b by dividing the length of the intermediate text (calculated in units equal to the length of the output of the round function used to update the intermediate text) by the number of rounds determined by step b.
d. calculating the number of rounds required to achieve at least three complete passes of the intermediate text by dividing the length of the intermediate text in blocks by the length of the output of the round function multiplied by the number of passes required.
e. calculating the largest number of rounds as determined by steps c and d as the minimum number of round functions that must execute before the output function is called.

7. Apparatus that receives as input variable length user data comprising at least 56 octets, the apparatus comprising:
an initialization module which implements an initialization process, the initialization process comprising the initialization of intermediate text which is of the same length as the length of the variable length user data;
a pass function module which implements at least one pass of at least one pass function, each pass function comprising:
the invocation of at least one round function, each round function:
receiving inputs comprising:
at least one reversible input selected from the intermediate text;
at least two irreversible inputs selected from the intermediate text, so that each pair of the at least two irreversible inputs selected from the intermediate text is separated by at least one bit of intermediate text; and
generating at least one reversible output that updates the intermediate text;
and in which: the sum of the length of the reversible and irreversible inputs received by the round function from the intermediate text is less than the length of the intermediate text in bits minus eight times the length of the sum of the output bits of the round function;
and comprising a sequence of steps that ensures each block of intermediate text is updated at least once from the output of a unique round function invocation; and
an output module which implements an output function, which output function releases a set of bits from the intermediate text only after the pass function has updated the intermediate text at least once.

8. Apparatus as claimed in claim 7, in which at least one round function invocation receives as at least one irreversible input at least a portion of the output of the immediately preceding round function invocation.

9. Apparatus as claimed in claim 7, in which the round function additionally receives at least one irreversible block of input regarding the reversible input.

10. Apparatus as claimed in claim 7, in which a single pass of the pass function ensures that each block of intermediate text is updated once by the output of a round function.

11. Apparatus as claimed in claim 7, in which the round function is a block cipher with irreversible inputs that are twice the length of its plaintext input.

12. Apparatus as claimed in claim 7, in which the minimum number of rounds is calculated by the steps comprising:
a. determining the number of rounds required for the output of the successive round functions to be computationally indistinguishable from random; and
b. setting the minimum number of rounds as a multiple of at least 3 times the number of rounds determined by the step a..
c. calculating the number of passes achieved by the number of rounds in step b by dividing the length of the intermediate text (calculated in units equal to the length of the output of the round function used to update the intermediate text) by the number of rounds determined by step b.
d. calculating the number of rounds required to achieve at least three complete passes of the intermediate text by dividing the length of the intermediate text in blocks by the length of the output of the round function multiplied by the number of passes required.
e. calculating the largest number of rounds as determined by steps c and d as the minimum number of round functions that must execute before the output function is called.
